(19) United States
(12) Patent Application Publication
(10) Pub. No.: US 2014/0289040 A1
(43) Pub. Date: Sep. 25, 2014

(54) Systems and Methods for Avoiding Undesirable Bundling and Use of Computer Applications

(71) Applicant: Mitch Green, Boulder, CO (US)

(72) Inventor: Mitch Green, Boulder, CO (US)

(73) Assignee: Adobe Systems Incorporated, San Jose, CA (US)

(21) Appl. No.: 12/645,662

(22) Filed: Dec. 23, 2009

(51) Int. Cl. G06Q 30/00

(52) U.S. Cl. 705/14.49

(57) ABSTRACT

Systems and methods are disclosed to avoid the undesirable offer, use, bundling, and other provision of applications. An application can be associated with categories or keywords and another application can be associated with restrictions prevented it from being used with applications associated with certain categories or keywords. If an application is associated with a subject matter categories that is on a subject matter exclusion list of another application, then those applications will not be used, shared, or bundled together. Similarly, an application can be prevented from use with another application based on keyword restrictions. If a first application is associated with particular keywords, such as keywords identifying market or brand, and second application identifies the same as restricted keywords, the second application will not be used with the first application. In some cases, competitors can use such techniques to prevent undesirable cross promotion, bundling, and sharing of applications.

### FIELD

This disclosure relates generally to computer software that runs, displays, provides, or otherwise uses electronic content.

### BACKGROUND

A term “application” can broadly be used to refer to anything that can be distributed or otherwise provided as a single executable or useable unit for use on a computing device. Various types of applications are used on computer devices to provide a wide variety of information and content. For example, widgets and other types of small applications are becoming increasingly common as a mechanism used to provide relatively discrete pieces of functionality, information, advertisement, and other content. With their increasing popularity and use, applications are the subject of new methods of sharing, bundling, and distribution. For example, an advertisement application may be offered in a bundle with a utility or entertainment application such that a user downloading the utility or entertainment application receives the advertisement application as well. Branded applications are also becoming common. For example, a shoe manufacturer may create its own branded application that provides information about one or more of its shoes.

Some of the new methods of bundling, sharing, and distributing applications, however, create the potential for an application to be offered with, used, or combined with another application in an objectionable way. For example, competing applications may be inadvertently packaged or otherwise provided together. Generally, business entities and others have an interest in ensuring that their applications, including their branded content and advertisements, are not paired or otherwise used with competitor applications or other objectionable or otherwise undesirable content. This potential problem is exacerbated by the fact that entities are taking on different roles in the new application distribution models, with entities sometimes acting as content creators, advertisement creators, publishers, advertisement hosts, and/or advertisers simultaneously. This may increase the chances, for example, of one competitor's branded application being paired with a second competitor's advertisement, to the disappointment of both. As a more specific example, if two competitors both offer applications, there is a potential that, if one of those competitors decides to host advertisements during copying of its application, the other competitor's advertisement application could be offered as well.

### SUMMARY

Systems and methods are disclosed to avoid the undesirable offer, use, bundling, and other provision of applications. An application can be associated with a restriction that prevents it from being offered, bundled, or used with any other applications associated with a certain category or keyword. If an application is associated with a subject matter category that is on a subject matter exclusion list of another application, then those applications will not be offered, used, shared, or bundled together. Similarly, an application can be prevented from being offered or used with another application based on keyword restrictions. If a first application is associated with particular keywords, such as keywords identifying market or brand, and a second application identifies the same terms as restricted keywords, the second application will not be offered or used with the first application. Competitors can use such techniques to prevent undesirable cross promotion, bundling, and sharing of applications.

One exemplary method comprises receiving a request to share a first application and determining an advertisement for a second application or advertisement while sharing the first application. Sharing the first application can involve various methods of sending or providing the first application elsewhere. One example of sharing an application is simply causing the application to be provided to another location. Another example is causing an embed code for the application to be provided to another location. In this exemplary method, the advertisement is determined by comparing information associated with the first application with information associated with the advertisement. In one example, the advertisement is determined by comparing a keyword or category associated with the first application with exclusion lists or inclusion lists associated with a plurality of potential advertisements. In another example, the advertisement is determined by comparing a keyword or category associated with the first application with inclusion lists or exclusion lists associated with a plurality of potential advertisements. Once an advertisement is identified or otherwise determined and upon initiation of sharing the first application, the advertisement or offer is presented.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram depicting an exemplary computing device for use in certain embodiments;

FIG. 2 depicts an exemplary advertising network in which techniques for avoiding the undesirable offer, use, bundling, and other provision of applications may be utilized;

FIG. 3 illustrates an exemplary user interface for registering a new application;

FIG. 4 illustrates additional features of the exemplary user interface of FIG. 3;

FIG. 5 illustrates an exemplary user interface for enabling cross-promotions for an application;

FIG. 6 illustrates an exemplary user interface for creating or editing an advertising campaign;

FIG. 7 illustrates additional features of the exemplary user interface of FIG. 6;

FIG. 8 is a flow chart of a method for avoiding the undesirable offer, use, bundling, and other provision of computer applications;

FIG. 9 is a flow chart of a method for providing sharing functionality within an application; and

FIG. 10 is a flow chart of a method for creating an advertisement campaign that includes a restriction with respect to the subject matter of an application that may host the advertisement.

### DETAILED DESCRIPTION

The methods and systems disclosed herein may be used in a variety of contexts and provide various advantages and features. To illustrate certain features and advantages the following discussion describes an embodiment in which applications and advertisements are prevented from being combined in specific sharing and advertising models. However, it will be understood by those of skill in this art that the methods and techniques may be used in other circumstances and may be modified and adjusted as appropriate to address the particular requirements presented by those circumstances.

Application distribution can involve copying an application from a server or other often remote content provider. In some circumstances, an application recipient may identify an application to receive and wait for the application to download. In other circumstances, a user may have already received an application and wish to share the application by including it in their own webpage or by sending it (or a link to it) to a friend. In these downloading, copying, sharing, and other circumstances, the user may initiate the transfer and, while waiting for the transfer to complete, be prompted with an advertisement, which itself may be another application.

Various advertisement systems and methods can cause an advertisement to be shown while an application is being transferred. In some circumstances, that advertisement may be for another application, which may be accessed or downloaded by interacting with the advertisement. Various revenue models can support these and similar advertising systems and methods. For example, the owner of the original application can receive revenue for allowing advertisements to be presented when the original application is transferred. An owner of the original application may agree to host advertisements in return for a fee, e.g., a specified amount of money each time an advertisement is played, each time such an advertisement generates interest, etc.

In various application sharing and distribution models, advertisement applications can be selected for offer or other use with host applications based on the content of both applications. For example, a baseball game application may host applications so that when a user transfers the baseball game application, an advertisement application is played. That advertisement may have been selected based on the baseball game application's content being sports-related. For example, the advertisement application may be for a sport equipment manufacturer advertisement. Thus, generally, matching an advertisement with a host application can be accomplished by associating the host application with one or more categories and associating the advertisement with one or more inclusion categories, i.e., specifying that the advertisement can be offered or used with any application associated with a specified inclusion category. In the above example, the hosting baseball game application may be associated with the topic category “sports” and the sport equipment manufacturer advertisement may have “sports” as a specified inclusion category.

Conversely, matching an advertisement with a host application can be accomplished by associating the advertisement application with one or more categories and associating the host application with one or more inclusion categories, i.e., specifying that the host application can be used with or offer any advertisement application associated with a specified inclusion category. In either of these examples, advertisement applications and host applications are matched with one another based on common association with one or more categories. Additional and alternative techniques may be used to match applications with one another including techniques that involve partial or complete random selection of applications.

There are also various techniques that can be employed to avoid the undesirable offer, use, bundling, and other provision of applications. An application can be associated with categories or keywords and another application can be associated with restrictions prevented it from being offered or used with applications associated with certain categories or keywords. Thus, categories may also be used to prevent advertisements and host applications from being used or offered together. A sports-related application provider can elect to block sports-related advertisements as a means of blocking potential competitors. For example, one or more exclusion categories may be specified for an advertisement, i.e., specifying that the advertisement cannot be used with or offered by any application associated with one of the specified exclusion categories. A sports advertiser might elect to not have their advertisement used with or offered by a sports application.

Generally, from an advertiser's perspective, to ensure appropriate or more desirable offering or other use of an advertisement, an advertiser could specify various information when creating an advertisement application campaign or for an already created campaign. The advertiser could indicate one or more particular categories to specifically target with the application. Such targeting could be implemented as provided a bias so that the application will be more likely to be used with the targeted category or may be implemented as a rule so that the application will only be used with the targeted category. Conversely, such targeting could also expressly exclude particular categories and, in such uses, will generally be applied as a rule so that the application will not be used with the targeted category.

From a host's perspective, an entity agreeing to allow its application to host (or otherwise be used with) an advertisement can provide various information that will be associated with its application to ensure appropriate or more desirable use of the application with potential advertisements. For example, where advertisements may be associated with one or more topic categories identifying the subject matter of the advertisement, a host application may identify one or more exclusion categories specifying that the host application cannot be used with any advertisement associated with one of the specified exclusion categories.

The term “category” is used here to refer to a topic, subject, or description that an application (hosting, advertisement, or other) is associated with that can be selected as defining or describing the content of an application. A “category” is selected from amongst a limited number of potential categories that are presented or available for possible association with an application. Such categories are generally predefined and broad so that they are applicable to many applications. Exemplary application topic categories are: business management, dating, family and living, health and fitness, internet, music and radio, science and nature, sports and recreation, travel, society and culture, movies and television, home and garden, gaming, explicit adult, computers and software, autos and transportation, alcohol, and education, entertainment, gambling, hobbies and interests, money and finance, news and reference, shopping, tobacco, etc.

In addition to, or as an alternative to, using categories selected from a limited number of potential categories, “keywords” may be used to prevent certain advertisements and host applications from being used or offered together. The term “keyword” refers to a word or phrase that is generally received as input from a user describing the content of an application. For example, in the above example, a user may enter “baseball” and “game” as keywords describing the hosting baseball game application. Because such keywords are received as input, they will typically be more specific than categories and may include specific trade and brand names.

In summary, in the context of the exemplary hosting/advertising sharing model described above, ensuring desirable application offering and other use can be accomplished using one or more inclusion and exclusion lists associated with either the host application or the advertisement application, or both, that identify categories and/or keywords that are compared with categories and keywords that define other applications. Thus, generally, an application, regardless of whether it is a host application or an advertisement application, can be associated with one or more of the following:
one or more descriptive categories selected from presented alternative;
one or more descriptive keywords that are entered as opposed to being selected;
an inclusion list identifying subject matters that candidate applications for bundling should be associated with; and
an exclusion list identifying subject matters that candidate applications for bundling should not be associated with.

This information can be compared between applications in various ways to select appropriate application bundles, i.e., to select an advertisement that is acceptable and/or appropriate for offering by or other use with a given host application. This information may also be used in other ways in addition or in the alternative. For example, an exclusion list keyword could be compared to other things besides the keywords that describe candidate advertisements. It could be compared against an advertisement application creator name, metadata associated with an advertisement, among many other things. Additionally, information that is associated with an application can be stored as part of the application within the application's code, declarative statements, metadata, watermarks, or otherwise, but, alternatively, or in addition, may be associated with an application in other ways as well. For example, information about an application may be stored in a cloud or on a remote database and accessed using, as an example, a unique identifier associated with the application.

These illustrative examples are given to introduce the reader to the general subject matter discussed here and are not intended to limit the scope of the disclosed concepts. The following sections describe various additional embodiments and examples with reference to the drawings in which like numerals indicate like elements.

### Illustrative Devices and Systems

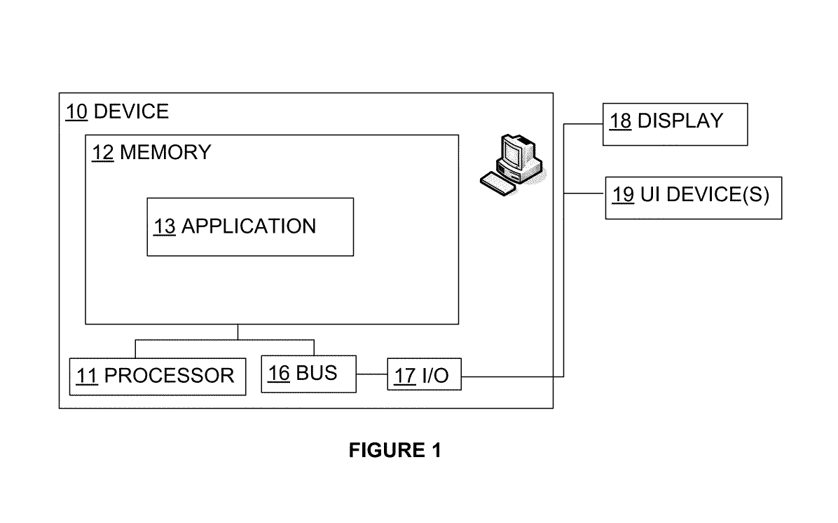

Referring now to the drawings in which like numerals indicate like elements throughout the several Figures, FIG. 1 is a block diagram depicting an exemplary computing device for use in certain embodiments. An exemplary application that executes on the exemplary device 10 is shown as a functional component. As is known to one of skill in the art, such applications may be resident in any suitable computer-readable medium and execute on any suitable processor. For example, as shown the network device 10 comprises a computer-readable medium such as a random access memory (RAM) 12 coupled to a processor 11 that executes computer-executable program instructions and/or accesses information stored in memory 12. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

The device 10 may also comprise a number of external or internal devices such as a mouse, a CD-ROM, DVD, a keyboard, a display, audio speakers, or other input or output devices. For example, device 10 is shown with a display 18 and various user interface devices 19. A bus, such as bus 16, will typically be included in the device 10.

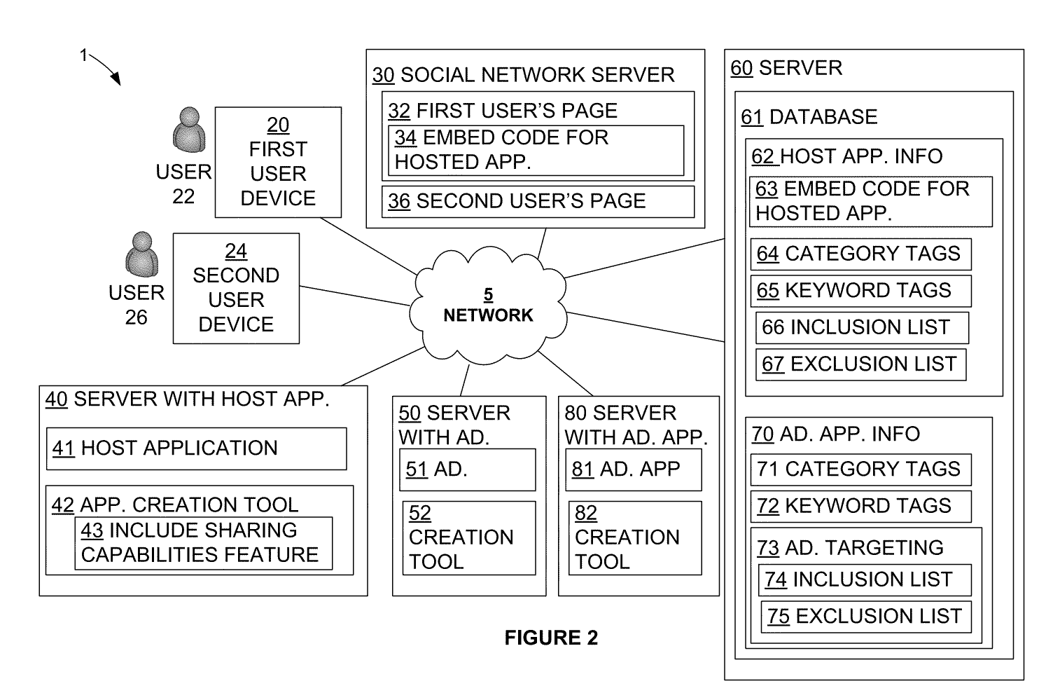

FIG. 2 depicts an exemplary advertising network in which techniques for avoiding the undesirable use, bundling, and other provision of applications may be utilized. The methods and systems disclosed herein are also applicable on other computing systems and environments. The environment 1 comprises a wired or wireless network 5 connecting various network devices 20, 24, 30, 40, 50, 60, 80, which may be configured, for example, with some or all of the components similar to those of device 10 of FIG. 1. The network 5 shown comprises the Internet. In other embodiments, other networks, intranets, combinations of networks, or no network may be used. Alternative configurations are possible. FIG. 2 illustrates a network in which a first user 22 using a first user device 20 can share a host application 41 with a second user 26 using a second user device 24. The host application 41 may be provided by a server 40 for download and use by users through the network 5.

One exemplary sharing scenario involves the second user 26 accessing the first user's page 32 from social network server 30. In this example, the first user's page 32 includes HTML statements that define a particular page that the second user 26 can access on the second user device 24 or elsewhere using a web browser application. The content of the first user's page 32 may include applications or links to applications that can be used within the first user's page 32. In this particular example, the first user's page 32 includes an HTML embed code 34 for the host application 41. This embed code 34 is embedded in the other HTML that defines the first user's page 32 and, when the first user's page 32 is loaded by a web browser, causes the host application 41 to be a part of the content that is displayed as the first user's page 32. The host application 41 can then be executed or otherwise used as part of the first user's page 32.

The second user 22 may choose to copy or otherwise incorporate content of the first user's page onto the second user's own page 36. This can be as simple as copying the embed code 34 for the host application 41 to the second user's page 36. As one example, the second user 26 may execute the host application 41 through the first user's page 32 as displayed on the second device 26. Within the host application 41, the second user 26 may select a share command to cause the host application 41 to be shared. In this case, the second user 26 wishes to use the share command to make the host application 41 a part of the second user's own page 36. As a result of using such a command and identifying the second user 26 as the recipient, the embed code 34 for the host application 41 may be copied and made a part of the second user's page 36. There are obviously many other ways of sharing and copying applications. For example, a link to the host application 41 or a copy of the actual host application 41 itself may be sent, for example, in an e-mail message.

In addition to these examples, there are various other ways in which the sharing or sending of an application can be initiated and carried out. The occurrence of a sharing event can be a convenient and acceptable time to display an advertisement or other application for use by the person initiating the sharing. For example, after selecting the share command in the above example, the first user 22 may be presented with an advertisement 51, received from server 50, that is played while the sharing transaction is completed and perhaps beyond. Such an advertisement may offer another application such as advertised application 81 on server 80. In this example, the sharing command is a part of the host application 41. Accordingly, the functionality to initiate the advertisement can be placed in the host application 41 and initiated after selection of the sharing command. In other systems, the functionality to initiate the advertisement may be placed elsewhere. In any case, in some circumstances, the provider of the host application 41 may be motivated to allow the sharing of host application 41 to initiate advertisements based on various incentive schemes. For example, the provider of the host application 41 may receive revenue for each advertisement that is offered, presented, clicked on, used, or upon some other appropriate metric.

In these and other networks that involve application offering, sharing, advertising, and/or bundling, various techniques may be employed to avoid the undesirable offering, use, bundling, and other provision of applications. Applications and advertisements, which themselves may or may not be applications, can be associated with information that prevents undesirable offering, bundling, and other uses. In FIG. 2, the host application 41 and the advertisement 51 are shown as associated with various exemplary pieces of information that can facilitate appropriate use of those pieces of content.

A server 60 provides a database 61 of information that facilitates appropriate pairing of applications with advertisements, including host application information 62 and advertisement application information 70. For example, if the host application 41 is shared, e.g., by a user using a sharing command when accessing the host application 41 on the first user's page 32, the sharing may trigger a call to the database 61 to retrieve host application information, such as category tags 64, keyword tags 65, an inclusion list 66, and an exclusion list 67, and advertisement application information 70 for one or more potential advertisements or advertisement applications. Exemplary information about an advertisement such as advertisement 51 includes category tags 71 and keyword tags 72. An advertisement may further be associated with advertisement targeting information 73 that provides an inclusion list 74 and/or and exclusion list 75.

These exemplary pieces of information provide a variety of ways in which advertisements can be selected for or excluded from being offering by or otherwise used with an advertisement host application. While the information is included in the respective applications and advertisements in this example, such information could be external to the applications and associated by a unique identifier or other appropriate association technique.

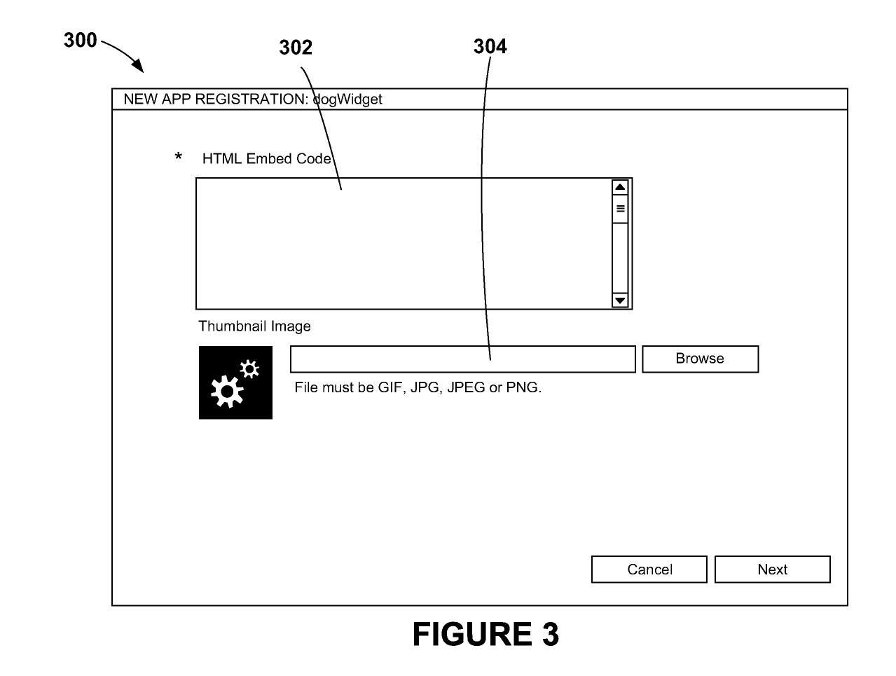

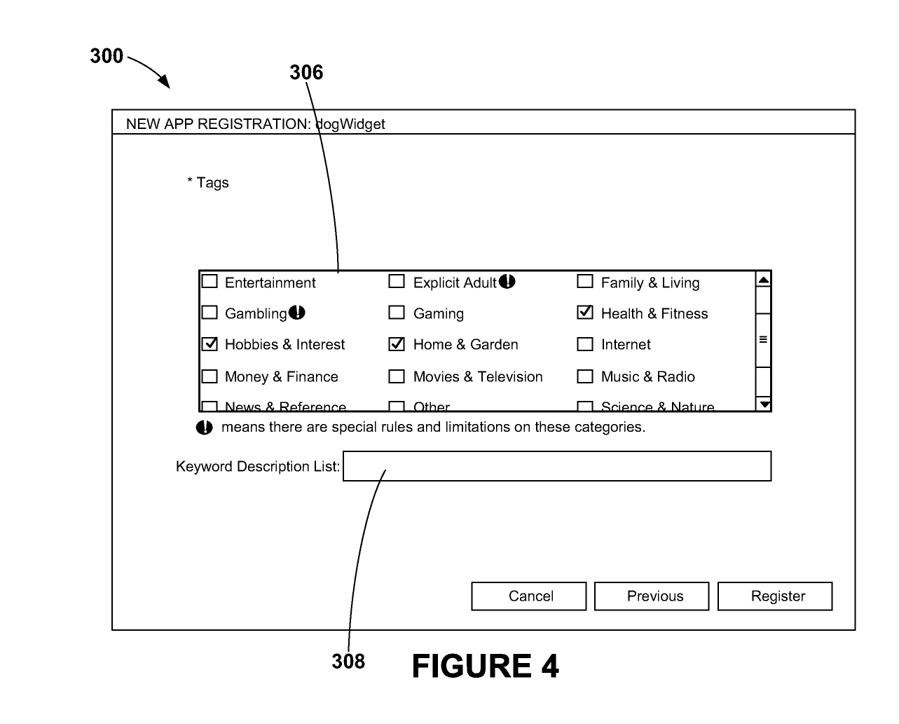

FIG. 3 and FIG. 4 illustrate an exemplary user interface 300 for registering a new application. In this example, the user interface 300 provides an HTML Embed Code field 302 that allows the entity or person registering the application to specify the HTML code that can cause the host application to be embedded in any HTML-based webpage. The user interface 300 also includes a Thumbnail Image field 304 for identifying an image to use as an icon for the application.

In FIG. 4, the user interface 300 includes a selection box 306 in which the entity or person registering the application can specify one or more categories that describe the content of the host application. These categories, as an example, could provide the category tags 64 of the host application 41 in FIG. 2. Similarly, if the advertisement 51 is being registered, the selection box 306 could be used to identify the category tags 71 of the advertisement application 51 of FIG. 2.

In FIG. 4, the user interface 300 further includes a Keyword Description List field 308 for entering keyword tags. Such keywords, as an example, could provide the keyword tags 65 of the host application 41 in FIG. 2. Similarly, if the advertisement 51 is being registered, the Keyword Description List field 308 could be used to identify the keyword tags 72 of the advertisement 51 of FIG. 2.

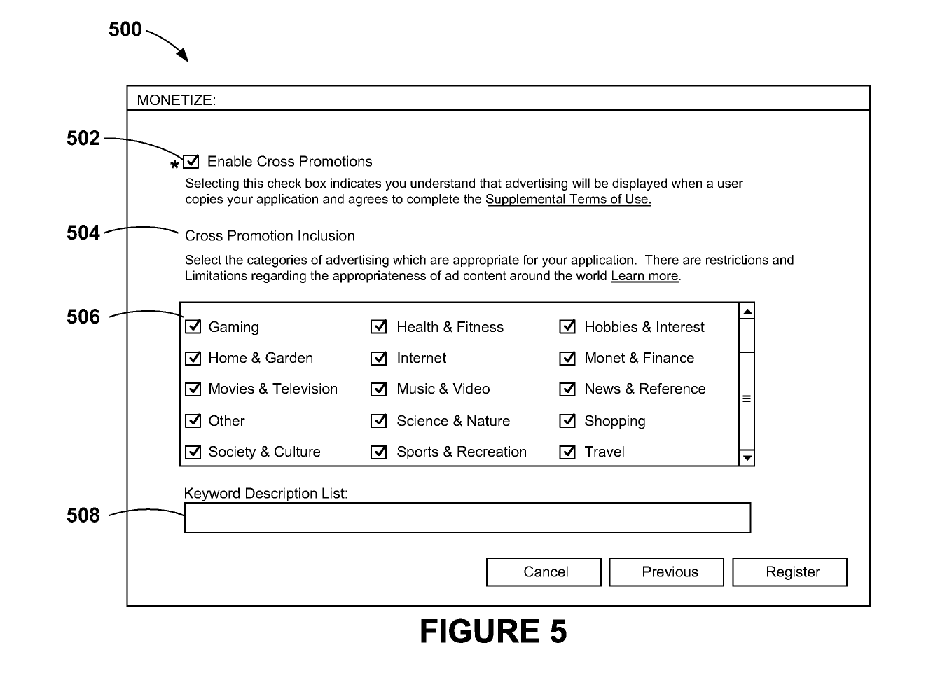

FIG. 5 illustrates an exemplary user interface 500 for enabling cross promotions for an application. Such a user interface 500 may be a part of an application registration process, such as a process involving the user interface 300 selections of FIG. 3 and FIG. 4. Alternatively, the user interface 500 or similar selections may be made as separately or as part of some other feature.

In FIG. 5, the user interface 500 presents an Enable Cross Promotions option 502. Selecting this option indicates that advertising will be displayed when a user copies the application. This is one example of a method of making an application a host application, i.e., an application that hosts advertisements and other applications. A Cross Promotion Inclusion instruction instructs the user to “Select the categories of advertising which are appropriate for your application,” among other things, and category selection area 506 allows a user to select one or more categories. These categories, as an example, could provide the inclusion list 66 associated with the host application 41 in FIG. 2.

In FIG. 5, the user interface 500 further includes a Keyword Exclusion List field 508 for entering keyword tags. These keyword tags are used to identify advertisements and applications that should not be promoted with the host application, i.e., advertisements associated with any keyword on the exclusion list will not be cross promoted.

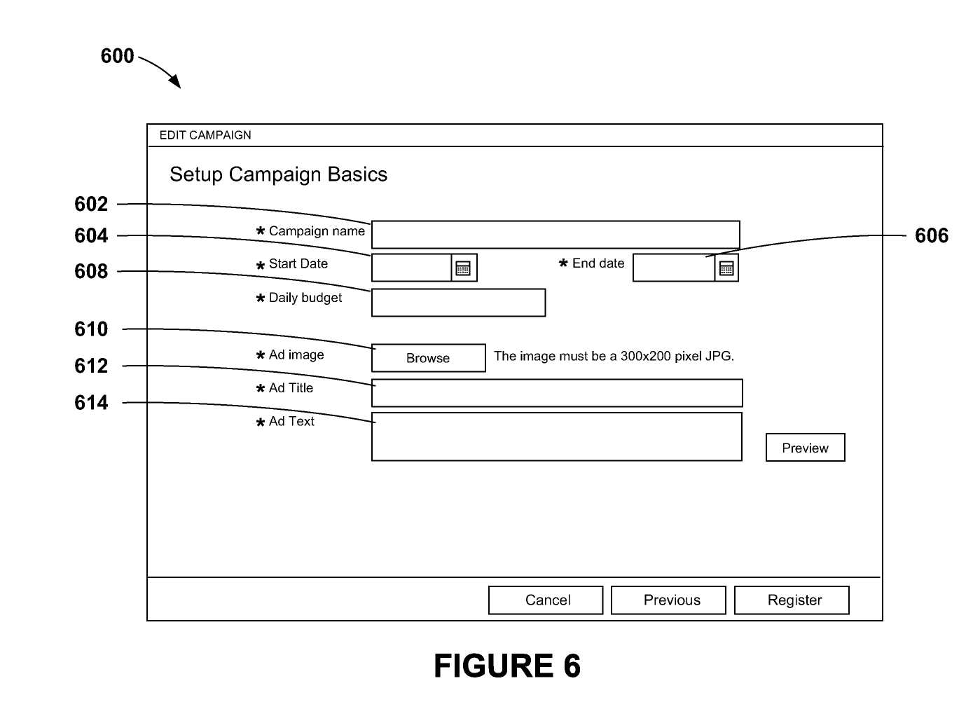

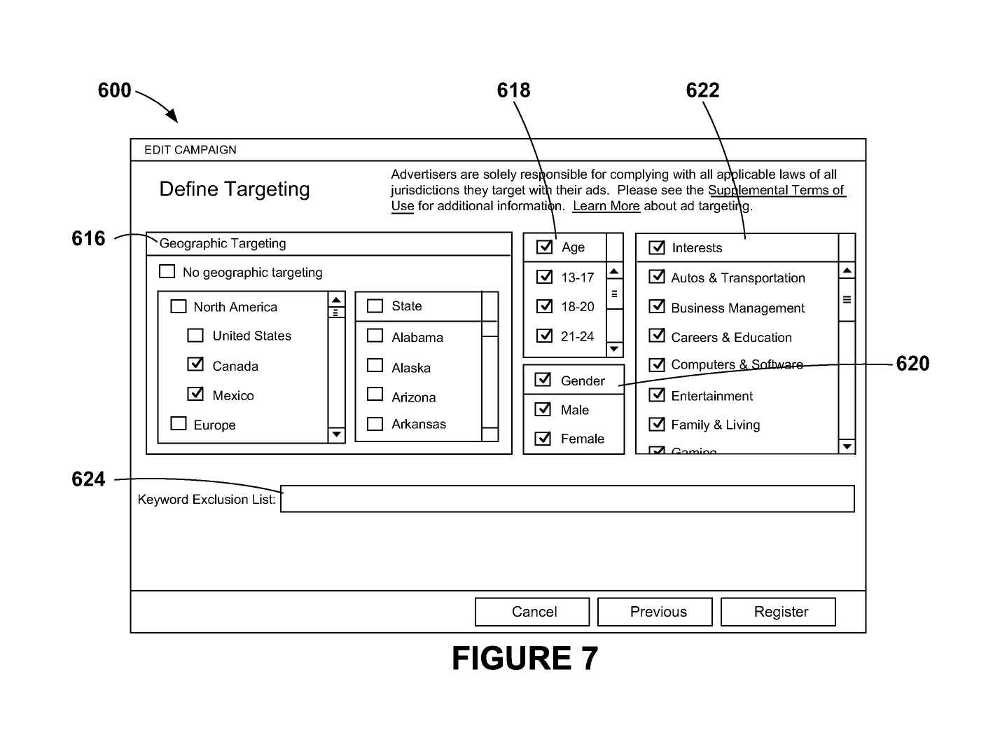

FIG. 6 and FIG. 7 illustrate an exemplary user interface 600 for creating or editing an advertising campaign. The user interface 600 allows a user to specify exemplary general information about the campaign, e.g., in a Campaign name field 602, a start date field 604, an end date field 606, and a daily budget 608 for specifying the maximum amount that should be spent in a given day to have the advertisement presented when another application (i.e., the host application) is transferred. Additional exemplary features include an Ad Image feature 610 for selecting an image to use for the advertisement, and Ad Title 612 feature for entering a title for the advertisement, and an Ad Text Field 614 for entering text information about the advertisement. Any or all of this information can be used in pairing an advertisement with an appropriate host application.

In FIG. 7, the user interface 600 allows entry of additional information to define the targeting of the advertisement for the ad campaign. The Geographic Targeting feature 616 allows selection of one or more specific geographic targets if desired. The Age feature 618 and Gender feature 620 allow targeting of particular end user attributes.

The Interests Targeting feature 622 allows targeting particular subject matter interests. Such targeting can be used, for example, to match with categories of host applications. In other words, if a particular end user is interested in transferring a particular host application, that user may be generally interested in the subject matter categories of that host application. An advertisement can target such interest by targeting the subject matter of the host application. The particular subject matters identified in such an Interest Targeting feature 622 can be appropriate for use as an inclusion list for an advertisement, e.g., inclusion list 74 of advertisement 51 of FIG. 2.

In FIG. 7, the user interface 600 further includes a Keyword Exclusion List field 624 for entering keyword tags. These keyword tags are used to identify host applications with which the advertisement should not be promoted, i.e., the advertisement will not be used with any host applications associated with any keyword on the exclusion list. Identifying competitor brands on such an exclusion list, as an example, can prevent the advertisement from being used with a host application that is somehow associated with a competitor of the advertiser.

Returning to FIG. 2, a server 60 provides a database 61 of information that facilitates appropriate pairing of applications with advertisements. For example, if the host application 41 is shared, e.g., by a user using a sharing command when accessing the host application 41 on the first user's page 32, the sharing may trigger a call to the database 61 to retrieve information 64, 65, 66, 67 about the host application and information 70 about one or more potential advertisements or advertisement applications. As an example, the information 62 about the host application may include category tags 64, keyword tags 65, and promotion information, including an inclusion list 66 and exclusion list 67, among other things. Similarly, the information 70 about one or more potential advertisements or advertisement applications may include category tags 71, keyword tags 72, and advertisement targeting information 73 including inclusion list 74 and exclusion list 75, among other things, as information about advertisement application 61 and similar information about other advertisement applications.

Generally, applications and advertisements can be created in a variety of ways. In the network shown in FIG. 2, the server 40 with the host application includes an Application Creation Tool 42 for creating an application, the server 50 with the advertisement 51 includes a Creation Tool 52 for creating an application, and the server with the advertised application 81 includes a Creation Tool 82 for creating the advertised application 81. Such tools could alternatively be used outside of these servers to create the respective applications ultimately provided from these servers 40, 50. Various applications also could be used to create an advertisement that is not an application, e.g., to create an advertisement that is a photograph, image, or video.

The exemplary Application Creation Tool 42 may include a variety of features for creating an application and may also include an Include Sharing Capabilities feature 43 that facilitates the building sharing or transferring capabilities into the application. Such a feature 43 may allow an application creator to easily add an end user controlled command to an application that allows the end user to share the application. For example, the Application Creation Tool 42 may provide a component that can be easily incorporated into an application that is being developed that provides most or all of this functionality built into it. In one embodiment, the feature provides an application being developed with functionality that provides a selectable feature, such as a button, in the application being developed that, when clicked, accesses a database of information, such as database 61, so that an appropriate advertisement can be selected and displayed while the application is shared.

An exemplary Include Sharing Capabilities feature 43 may or may not allow an application creator to input information to register an application and use such an application as a hosting application, e.g., by providing user interfaces such as those illustrated in FIGS. 3, 4, and 5. Similarly, an exemplary Include Sharing Capabilities feature may or may not allow an application creator to configure an application as an advertisement to be used in an advertisement campaign, for example, by providing, among other things, the user interface of FIGS. 6 and 7. Alternatively, or additionally, an already created application or advertisement may be configured with sharing, hosting, and/or advertisement campaign information through one or more applications or interfaces that are not part of the application or advertisement creation environments.

One embodiment provides software that allows advertisers to create and manage advertisement campaigns in an advertisement network. Similarly, the same or additional software can also allow application publishers to opt into hosting advertisements in this advertisement network. The software can bring advertisement hosts and advertisers together without the different parties having to directly interact. In an exemplary circumstance, a host application creator tags the host application with appropriate categories and keywords. The creator also opts into the advertisement network as an advertisement host and describes, through inclusion and exclusion lists, the advertisements that are appropriate to be displayed with the host application. The advertiser creates an advertisement campaign and describes, through inclusion and exclusion lists, the kinds of applications that the application should be offered by or otherwise used with. A database system can be provided to match advertisements with host applications. Once established, each time an advertisement is displayed and/or interacted with, the advertiser pays an advertising commission. Such a commission can go to one or more of the host application publisher, the database provider, the application tool provider, and/or any appropriate combination of these parties who may have each contributed to or otherwise helped facilitate the successful advertisement campaign. Certain embodiments provide unique possibilities for cross promotion of widgets and other applications and certain embodiments are configured to exploit the portable and viral nature of many applications.

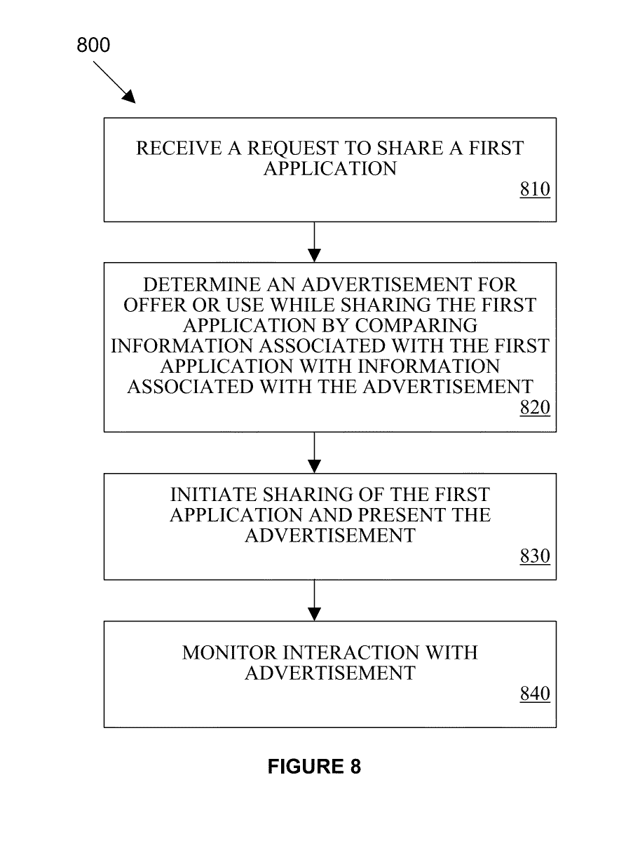

FIG. 8 is a flow chart of method 800 for avoiding the undesirable use, bundling, and other provision of computer applications. This exemplary method 800 involves receiving a request to share a first application, as shown in block 810. Sharing the first application can involve various methods of sending or providing the first application elsewhere. One example of sharing an application is simply causing the application to be provided to another location. Another example is causing an embed code for the application to be provided to another location.

A request to share an application similarly involves a variety of different types of requests. In one example, a request to share the first application is initiated by selection of an option provided within the first application. For example, a first application may be a widget or small application that is accessed through a web page viewed using a web browser. The widget or small application may include interactive content including a button or other option to share the application, e.g., a “GET THIS,” button, a “SHARE THIS APPLICATION” button, etc. Generally, such an option could have any of a variety of names and can generally provide the functionality of sharing the application upon selection by a user of the application. Alternatively, a request to share an application may be received by an option selected from within a webpage but outside of the application which is embedded within that webpage as the target of the sharing. Other alternative methods for providing share request options and receiving share requests may also be used.

In the exemplary method 800, in response to receiving the request to share the first application, an advertisement is identified or otherwise determined by comparing information associated with the first application with information associated with the advertisement, as shown in block 820. Information associated with the first application and the information about the advertisement can be received from a database, from the application and advertisement themselves, or otherwise as may be appropriate for a particular implementation. For example, the information associated with the first application may be stored as part of the first application (e.g., within the code, statements, or metadata of the application) and retrieved from within the first application when needed. An advertisement may be a static image, simple text, a web page, a rich Internet application, or any other type of application or non-application content.

In one example, the advertisement is determined by comparing a keyword associated with the first application with exclusion lists associated with a plurality of potential advertisements, wherein the keyword associated with the first application is not listed on the exclusion list of the advertisement for use while sharing the first application. For example, if the first application is associated with a keyword: “BRAND NAME X” any advertisement having an exclusion list that identifies “BRAND NAME X” will not be selected for use and thus the advertisement that is selected will not have “BRAND NAME X” on its exclusion list.

As another example, the advertisement may be determined by comparing a category associated with the first application with exclusion lists associated with a plurality of potential advertisements, wherein the category associated with the first application is not listed on the exclusion list of the advertisement for use while sharing the first application. For example, if the first application is associated with a category: “GAMING” any advertisement having an exclusion list that identifies “GAMING” will not be selected for use and thus the advertisement that is selected will not have “GAMING” on its exclusion list.

Another example involves determining an advertisement by comparing a keyword associated with the first application with inclusion lists associated with a plurality of potential advertisements, wherein the keyword associated with the first application is listed on the inclusion list of the advertisement that is determined for use while sharing the first application. For example, if the first application is associated with a keyword: “RUNNING SHOE,” an advertisement can be selected because it has an inclusion list that identifies “RUNNING SHOE.” Such an advertisement may be a good match for the first application given this association.

As another example, the advertisement may be determined by comparing a category associated with the first application with inclusion lists associated with a plurality of potential advertisements, wherein the category associated with the first application is listed on the inclusion list of the advertisement that is determined for use while sharing the first application. For example, if the first application is associated with a category: “ENTERTAINMENT,” an advertisement can be selected because it has an inclusion list that identifies “ENTERTAINMENT.” As in the previous example, the match provides an indication that the selected advertisement is a good match for the first application.

Inclusion lists and/or exclusion lists associated with the first application can also be used for determining an appropriate advertisement. For example, the advertisement can be determined by determining that a category or keyword associated with the advertisement is not on an exclusion list associated with the first application. For example, if the first application has an exclusion list that identifies “TRADEMARK X,” than a potential advertisement will only be selected for use if it is not associated with a keyword “TRADEMARK X.”

Once an advertisement is identified or otherwise determined and upon initiation of sharing the first application, the advertisement is presented, as shown in block 830. In some circumstances, sharing an application can involve downloading the application itself and/or information about the application, such as information that identifies the location of the application for use in an embed code.

The method 800 further involves monitoring the interaction with the first advertisement, as shown in block 840. For example, this may involve determining whether a user interacts with the advertisement in a particular way desired by the advertiser. The user may interact with the advertisement to purchase a second application or another product or service. Such interaction, whether it is a purchase or any other interaction from which user interest may be inferred, can provide a basis for compensating the host of the first application. For example, an entity hosting the first application may receive compensation from the advertiser for allowing the advertisement to be provided during sharing of the first application and may receive additional compensation in circumstances in which the user interaction with the advertisement confirms interest in the advertisement subject matter, and still additional compensation if the user interaction involves a purchase. Various additional or alternative advertisement models may be used.

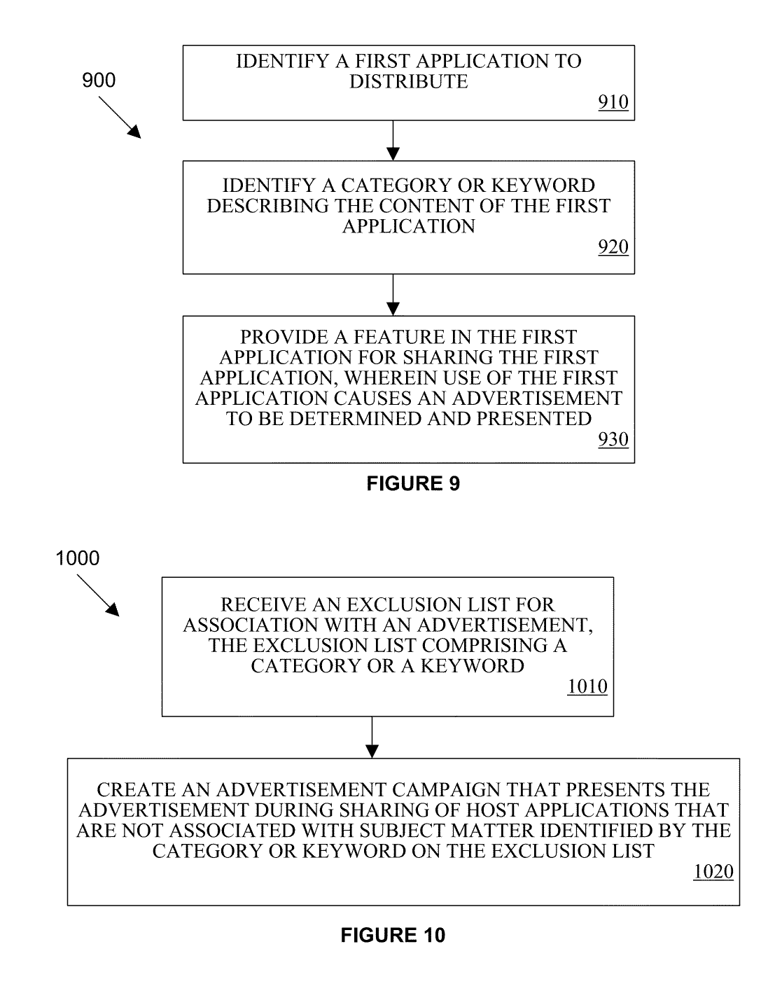

FIG. 9 is a flow chart of method 900 for providing sharing functionality within an application. This exemplary method 900 involves identifying a first application to distribute, as shown in block 910. This may involve receiving a selection of an application name in a user interface in an application creation/editing environment. Alternatively, it could be as simple as a user opening a new or existing application for editing in an application creation/editing environment.

The method 900 involves, for the first application, identifying a category for use in selecting an advertisement for offering or other use while sharing of the first application or a keyword for use in selecting the advertisement for offering or other use while sharing of the first application, as shown in block 920. This identification may occur in an application creation/editing environment or may occur through any other suitable interface. For example, a user interface may be provided for a user to enter information about an already existing application, without providing any other mechanisms for the user to edit the application.

Sharing the first application can involve various methods of sending or providing the first application elsewhere. One example of sharing an application is simply causing the application to be provided to another location. Another example is causing an embed code for the application to be provided to another location.

The method 900 further involves providing a feature in the first application for sharing the first application, wherein use of the feature during use of the first application causes an advertisement to be determined and presented, as shown in block 930. Thus, when the first application is ultimately used, upon initiation of sharing the first application, the advertisement is presented. The advertisement is selected using the category describing the content of the first application or the keyword describing the content of the first application. The advertisement may be selected, at least in part, because the category or keyword identifies a subject matter with which that advertisement is not associated. Conversely, the advertisement may be selected, at least in part, because the category or keyword identifies a subject matter with which the advertisement is associated.

FIG. 10 is a flow chart of method 1000 for creating an advertisement campaign that subject matter with which a host application may not be associated. The exemplary method involves receiving an exclusion list for association with an advertisement, wherein the exclusion list comprises a category or a keyword, as shown in block 1010. This may involve receiving a selection of categories or input specifying keywords in a user interface in an advertisement creation/editing environment. Alternatively, it could be as simple as a user entering selections or text into an interface that allows such a user to create or edit an advertisement campaign for an already existing advertisement.

The method 1000 further involves creating a campaign for the advertisement that presents the advertisement during sharing of host applications that are not associated with subject matter identified by the category or keyword on the exclusion list. For certain sharing/advertising networks, upon initiation of sharing of a host application, the advertisement is presented. For example, upon selection of an option to share a host application, an advertisement may be selected and then presented.

In certain embodiments, an advertisement may also be associated with an inclusion list identifying a category or a keyword that describes the subject matter with which a host application with which the advertisement is used must be associated.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A computer-implemented method comprising:
receiving a request to share a first application;
in response to the request, determining an advertisement for use while sharing the first application, wherein the advertisement is determined by comparing category or keyword information associated with the first application with category or keyword information associated with the advertisement; and
sharing the first application, wherein upon initiation of sharing the first application, the advertisement is presented, wherein the receiving, determining, and sharing are performed via a processor;
wherein sharing the first application comprises sending the application to another location, wherein the advertisement is presented at the another location while the sending occurs.

2. The method of claim 1 wherein sharing the first application comprises causing the first application to be provided to another location or causing an embed code for the first application to be provided to another location, wherein the advertisement is presented while the first application or embed code is being sent.

3. The method of claim 2 wherein the request to share the first application is initiated by selection of an option provided within the first application.

4. The method of claim 1 wherein determining the advertisement comprises comparing a keyword associated with the first application with exclusion lists associated with a plurality of potential advertisements, wherein the keyword associated with the first application is not listed on an exclusion list of the advertisement for use while sharing the first application.

5. The method of claim 1 wherein determining the advertisement comprises comparing a category associated with the first application with exclusion lists associated with a plurality of potential advertisements, wherein the category associated with the first application is not listed on an exclusion list of the advertisement for use while sharing the first application.

6. The method of claim 1 wherein determining the advertisement comprises comparing a keyword associated with the first application with inclusion lists associated with a plurality of potential advertisements, wherein the keyword associated with the first application is listed on an inclusion list of the advertisement for use while sharing the first application.

7. The method of claim 1 wherein determining the advertisement comprises comparing a category associated with the first application with inclusion lists associated with a plurality of potential advertisements, wherein the category associated with the first application is listed on an inclusion list of the advertisement for use while sharing the first application.

8. The method of claim 1 wherein the advertisement is determined by determining that a category or keyword associated with the advertisement is not on an exclusion list associated with the first application.

9. The method of claim 1 wherein the advertisement is determined by determining that a category or keyword associated with the advertisement is on an inclusion list associated with the first application.

10. The method of claim 1 wherein the information associated with the first application and the information about the advertisement is received from a database while determining the advertisement for use while sharing the first application.

11. The method of claim 1 wherein the information associated with the first application is stored as part of the first application and retrieved from within the first application while determining the advertisement for use while sharing the first application.

12. The method of claim 1 wherein the advertisement is a second application.

13. A system comprising:
a component for, via a processor, identifying a first application to distribute;
a component for, via a processor, tagging the first application with a category describing content of the first application or a keyword describing content of the first application; and
a component for, via a processor, providing a feature in the first application for sharing the first application, wherein use of the feature during use of the first application causes an advertisement to be determined and presented, wherein upon initiation of sharing the first application, the advertisement is presented, wherein the advertisement is selected using the category describing the content of the first application or the keyword describing the content of the first application;
wherein sharing the first application comprises sending the application to another location, wherein the advertisement is presented at the another location while the sending occurs.

14. The system of claim 13 wherein sharing the first application comprises causing the first application to be provided to another location or causing an embed code for the first application to be provided to another location.

15. The system of claim 13 wherein the advertisement is selected, at least in part, because the category or keyword identifies a subject matter with which that advertisement is not associated.

16. The system of claim 13 wherein the advertisement is selected, at least in part, because the category or keyword identifies a subject matter with which that advertisement is associated.

17-20. (canceled)

21. The method of 1 wherein sharing the first application comprises sending the application to another location, wherein the advertisement is presented while the sending occurs.

22. The method of claim 1 wherein sharing the first application comprises incorporating the first application into a web page by copying an embed code for the application to the web page, wherein, once embedded, when the web page is loaded by a web browser, the embed code causes the application to be a part of the content that is displayed.

23. A computer-implemented method comprising:
receiving a request to share a first application;
in response to the request, determining an advertisement for use while sharing the first application, wherein the advertisement is determined by comparing category or keyword information associated with the first application with category or keyword information associated with the advertisement;
sharing the first application, wherein upon initiation of sharing the first application, the advertisement is presented, wherein the receiving, determining, and sharing are performed via a processor; and
wherein determining the advertisement comprises comparing a keyword associated with the first application with exclusion lists associated with a plurality of potential advertisements, wherein the keyword associated with the first application is not listed on an exclusion list of the advertisement determined for use while sharing the first application.
